(19) United States
(12) Patent Application Publication
(10) Pub. No.: US 2009/0031655 A1
(43) Pub. Date: Feb. 5, 2009

(54) Structural sandwich plate members

(76) Inventors: Stephen John Kennedy, Ottawa (CA); Howard Mackenzie Wilson, Enstone (GB)

Correspondence Address: NIXON & VANDERHYE, PC, 901 NORTH GLEBE ROAD, 11TH FLOOR, ARLINGTON, VA, 22203, US

(21) Appl. No.: 11/596,708

(22) PCT Filed: May 18, 2005
(86) PCT No.: PCT/GB05/01958

§ 371 Date: Oct. 16, 2008

(30) Foreign Application Priority Data
May 21, 2004 (GB) 0411413.8

(51) Int. Cl. B32B 15/08; B23P 17/00; E04C 1/00; B23B 35/00; B23K 31/00; B23K 20/12

(52) U.S. Cl. 52/309.14; 29/897.32; 29/897.3; 408/1 R; 219/117.1; 228/112.1

(57) ABSTRACT

A structural sandwich plate member is provided with at least one stud welded to one or both of the outer plates and extending into the core. The stud may be arc stud welded to the outer plate before formation of the core. Alternatively, the stud may be installed after formation of the core by drilling a hole in one outer plate and friction welding the stud to one or both outer plates.

The present invention relates to structural sandwich plate members which comprise two outer plates and a core of plastics or polymer material bonded to the outer plates with sufficient strength to substantially contribute to the structural strength of the member.

Structural sandwich plate members are described in U.S. Pat. No. 5,778,813 and U.S. Pat. No. 6,050,208, which documents are hereby incorporated by reference, and comprise outer metal, e.g. steel, plates bonded together with an intermediate elastomer core, e.g. of unfoamed polyurethane. These sandwich plate systems may be used in many forms of construction to replace stiffened steel plates, formed steel plates, reinforced concrete or composite steel-concrete structures and greatly simplify the resultant structures, improving strength and structural performance (e.g. stiffness, damping characteristics) while saving weight. Further developments of these structural sandwich plate members are described in WO 01/32414, also incorporated hereby by reference. As described therein, foam forms may be incorporated in the core layer to reduce weight and transverse metal shear plates may be added to improve stiffness.

According to the teachings of WO 01/32414 the foam forms can be either hollow or solid. Hollow forms generate a greater weight reduction and are therefore advantageous. The forms described in that document are not confined to being made of light weight foam material and can also be make of other materials such as wood or steel boxes, plastic extruded shapes and hollow plastic spheres.

A particular advantage of such structural sandwich plate members is that shear forces are transferred by the core and its natural adhesion to the outer plates. A sufficient bond is achieved on casting of the core material so that no special means is required to connect the core and the outer plates (save for suitable surface preparation), which makes fabrication of the plates rapid and economic. For certain environmental or operational loads and conditions—such as: temperatures below −20° C.; attachment of fittings post injection where welding may reduce the bond strength; or where direct tensile loads in excess of the local bond strength are to be applied—mechanical methods must be used to enhance the bond strength between the core and metal face plates.

It is an aim of the present invention to provide structural sandwich plate members that have an improved connection between core and outer plates.

According to the present invention, there is provided: a structural sandwich plate member comprising:

first and second outer metal plates;

a core of plastics or polymer material bonded to said outer plates with sufficient strength to transfer shear forces therebetween; and

at least one mechanical connector welded to at least one outer plate, the mechanical connector comprising a cylindrical metal body extending into said core generally perpendicularly to said one outer plate.

The mechanical connector(s), which may be studs, may be applied either before casting of the core material or after the core has been set. In either case, the connector provides an improved connection between the core and the outer plates in both shear and tension by mechanical interlock. The connector can therefore prevent localised delamination in the event, for example, of damage due to welding to the outer plates, if large tension loads are applied to one of the outer plates, or if the plates are subjected to extreme cold temperatures. A connector may be welded to both outer plates to provide a direct path to transfer forces between the outer plates to mitigate delamination.

Before the casting of the core material, the connectors can be attached by arc stud welding or variants on that technique. Use of a stud welding “gun” allows connectors to be attached extremely quickly and may also be automated. The connectors preferably have an enlarged head to provide a mechanical interlock with the core material in more than one direction and may extend for only part of the core thickness or for the full core thickness. In the latter case, the studs may act as spacers for the plates prior to the injection of the core, without needing to be welded to the other outer plate. The studs can be applied to either or both outer plates and are preferably located in areas where enhanced local bond strength is required.

After fabrication of a structural sandwich plate member, the studs may be attached by drilling through one outer plate and into the core and then friction welding the stud in the hole. The hole in the outer plate is preferably countersunk and the stud is provided with an enlarged head and matching bevel. If the stud is to span the full width of the core, the drilling step should penetrate to the other (distal) outer plate. The stud is preferably slightly longer, from the bottom of the bevel to the tip, than the distance between the bottom of the countersink and the other outer plate. Then, when the friction weld is formed, a weld pool is first formed between the end of the stud and the distal outer plate and when the stud sinks into that the bevel of the head of the stud contacts the countersink in the proximal outer plate and forms a weld there. The part of the enlarged head that remains above the proximal outer plate after the weld is formed may be ground flush with the outer plate or used as an attachment point.

The materials, dimensions and general properties of the outer plates of the structural sandwich plate member of the invention may be chosen as desired for the particular use to which the structural sandwich plate member is to be put and in general may be as described in U.S. Pat. No. 5,778,813 and U.S. Pat. No. 6,050,208. Steel or stainless steel is commonly used in thicknesses of 0.5 to 20 mm and aluminium may be used where light weight is desirable. Similarly, the plastics or polymer core may be any suitable material, for example an elastomer such as polyurethane, as described in U.S. Pat. No. 5,778,813 and U.S. Pat. No. 6,050,208. The material of the studs should be the same or weld compatible with the material of the outer metal plates and the dimensions of the studs will be selected according to the loads to be expected in use. In the case of a full-thickness stud to be welded to outer plates of dissimilar metals a two part stud might be used.

The studs may of course be used in structural sandwich plate members formed as new and in those formed as over- or inner-lays to existing structures, as described in International Applications WO02/20341 and PCT/GB2003/004628, which documents are hereby incorporated by reference.

Further, the invention provides a method of manufacturing a structural sandwich plate member comprising the steps of:

providing first and second outer metal plates,

welding at least one stud to at least one of said outer plates;

placing said outer plates in a spaced-apart relationship with said at least one stud projecting into the space defined between said outer plates;

injecting uncured plastics or polymer material to fill said space defined between said outer plates; and

allowing said plastics or polymer material to cure to bond said outer plates together with sufficient strength to transfer shear forces therebetween.

Still further, the present invention provides a method of attaching a shear stud to a structural sandwich plate member comprising first and second outer metal plates and a core of plastics or polymer material bonded to said outer plates with sufficient strength to transfer shear forces therebetween, the method comprising the steps of:

drilling a hole through a first one of the outer plates of said structural sandwich plate member and into the core thereof;

providing a stud;

inserting said stud into said hole and welding said stud to said first outer plate.

The present invention will be described below with reference to exemplary embodiments and the accompanying schematic drawings, in which:

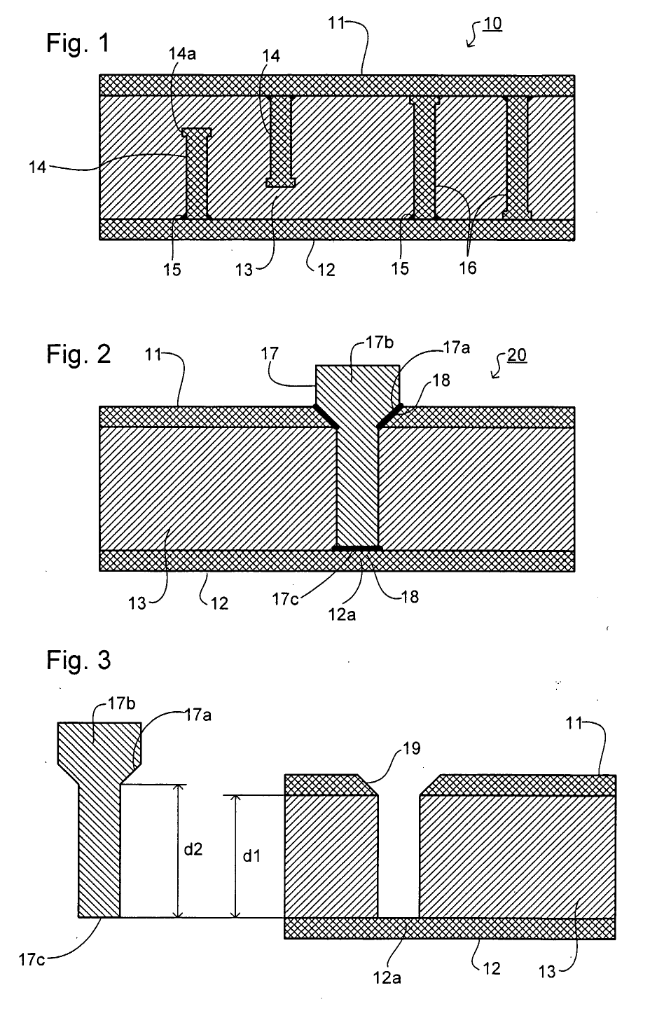

FIG. 1 is a cross-sectional view of a structural sandwich plate member according to a first embodiment of the present invention;

FIG. 2 is a cross-sectional view of a structural sandwich plate member according to a second embodiment of the present invention; and

FIG. 3 is a cross-sectional view of a structural sandwich plate member according to the second embodiment of the present invention and the stud, prior to insertion of the stud and

In the various drawings, like parts are indicated by like reference numerals.

The structural sandwich plate member shown in FIG. 1 comprises upper and lower outer plates (faceplates) 11, 12 which may be of steel or aluminium and have a thickness, for example, in the range of from 0.5 to 20 mm. Edge plates are welded between the face plates 11, 12 around their outer peripheries to form a closed cavity. In the cavity between the face plates 11, 12 is a core 13 of plastics or polymer material, preferably a compact thermosetting material such as polyurethane elastomer. This core may have a thickness in the range of from 15 to 200 mm; in the present application 50 mm is suitable. The core 13 is bonded to the face plates 11, 12 with sufficient strength and has sufficient mechanical properties to transfer shear forces expected in use between the two face plates. The bond strength between the core 13 and face plates 11, 12 should be greater than 3 MPa, preferably 6 MPa, and the modulus of elasticity of the core material should be greater than 200 MPa, preferably greater than 250 MPa, especially if expected to be exposed to high temperatures in use. For low load applications, such as floor panels, where the typical use and occupancy loads are of the order of 1.4 kPa to 7.2 kPa, the bond strength may be lower, e.g. approximately 0.5 MPa. By virtue of the core layer, the structural sandwich plate member has a strength and load bearing capacity of a stiffened steel plate having a substantially greater plate thickness and significant additional stiffening. The plate, of course, need not be flat but may take any form required for its intended use.

To improve the connection between the core and the outer plates, a number of mechanical connectors, in this embodiment studs 14, 16, are provided on the inners surfaces of either or both of the outer plates, projecting into the core. The studs may project only part of the core thickness, as in studs 14, or the full core thickness, as in studs 16.

The studs are made of the same material as the outer plate to which they are attached, or a weld compatible material, and are attached by welds 15. Full-thickness studs need not be welded to both outer plates.

An enlarged head 14a is preferably provided on the studs to improve keying (mechanical interlock) to the core material. The studs may be specifically designed for the application or may be standard studs available “off-the-shelf” from a variety of suppliers.

To manufacture the structural sandwich plate member 10, studs are welded as required to the inner surfaces of one or both outer metal plates. This is preferably done by an arc welding process and a stud welding “gun” of conventional type can be used to attach studs with ease and great rapidity. The edge plates are then welded around the periphery of lower faceplate 11. At this stage, any precast sections of the core may be put in place as well as any forms shear plates or other fittings that may be desired. Then, the upper faceplate 12 is welded to the edge plates or perimeter bars or connection details to form a closed cavity and the plastics or polymer material injected to form core 13. The injected material is then allowed to cure and the injection ports used in the injection step ground off and sealed along with the vent holes. These steps may be performed in situ, or off-site in factory conditions and the finished panel transported to the installation site.

The procedure is essentially the same where shear studs are used in a structural sandwich plate formed as an overlay to an existing structure. The studs may be welded to the existing plate or the new overlay plate, or both, and may act as spacers to position and/or support the new overlay plate relative to the existing plate.

A second embodiment of the present invention is shown in FIG. 2. The structural sandwich plate member 20 according to the second embodiment of the invention is similar to the first embodiment but the mechanical connectors (studs) are applied after manufacture of the plate, as described below.

In the second embodiment, the stud 17 is fitted from the outside after fabrication of the complete structural sandwich plate member. Stud 17 penetrates a first, proximal one of the outer plates and extends through the full core thickness to the second, distal outer plate. Friction welds 18 are formed between a bevel 17a on the enlarged head 17b of the stud 17 and the countersunk hole in the proximal outer plate 11 and between the distal tip 17c of stud 17 and a recess 12a formed in the inner surface of distal outer plate 12. The tip 17c may be flat, as illustrated, or bevelled. Also, the head 17b may be flat, rather than bevelled, to provide a landing edge onto the top plate.

The process for fitting the shear stud to the previously fabricated structural sandwich plate member is as follows. First a hole is drilled through the proximal plate 11, core 13 and into distal plate 12. The depth of this hole is controlled to be within a specified tolerance of a nominal depth d1, measured from the inner surface of the proximal plate 11. The hole 19 in the proximal plate 11 is then countersunk to a predetermined size. The shank of stud 17 has a nominal length d2, from the bottom of the bevel 17a to its tip, that is slightly greater than depth d1. The tolerances on d1 and d2 must be such that d2 is always greater than d1 and within normal tolerances associated with friction welding. The tolerance on the length of the stud must also be such as to provide adequate weld fusion between the end 17c of the connector and the weld point 12a as well as between the bevel 17a and countersink 19.

The stud 17 is then inserted into the hole and rotated at high speed whilst being pressed into the hole—this can be performed by a conventional friction stud welding device. The required pressure can be obtained using a strong back, if the sandwich plate member is loose, or by electromagnetic or vacuum clamps, especially if the plate member is already installed in a structure. Initially, the tip 17c of the stud will contact the recess 12a in the distal plate but as the weld pool is formed there, the stud will go in further until contact is made between the bevel 17a and countersink 19 and a weld pool is formed there. When the rotation of the stud is stopped, the weld pools will solidify and the stud will be welded at each end. It will be appreciated that the thickness of the core of the sandwich plate member must be to the same tolerance as the stud to ensure fusion of the stud to both face plates. The weld quality may be verified by normal non-destructive testing methods such as ultrasonic or x-ray inspection techniques.

After the stud has been welded in place, the protruding head and any flash collar may be ground off. Alternatively, the head may be used as a point of attachment for a fixing and may therefore be provided with an exposed thread. In the case of particularly heavy loads, a number of studs may be installed in close proximity; the only limits to their closeness being the requirement that the countersunk holes in the top plate not interfere and any requirements imposed by the welding machine head. Studs may be installed for either or both sides of the plate as convenient for access and ease of installation, especially if the plate is already installed in a structure.

By appropriate choice of the size and spacing of the studs and perforations, the upper plate can be connected to the lower plate sufficiently to restrain it against the pressure experienced during injection, thus obviating the need for external restraints. Depending on the application, the studs need not contribute significantly to the strength of the completed structural sandwich plate member but the size and spacing of the studs can be chosen to provide additional strength if desired. The perforations 11a should be made as small as possible whilst still allowing easy formation of the tack welds whereas the enlarged heads 20a should be made large enough to ensure, given allowed tolerances in the positions of the perforations and studs, that the holes are completely within the areas of the heads of the studs and there is no leak to the core cavity.

It will be appreciated that the above description is not intended to be limiting and that other modifications and variations fall within the scope of the present invention, which is defined by the appended claims.

1. A structural sandwich plate member comprising:
first and second outer metal plates;
a core of plastics or polymer material bonded to said outer plates with sufficient strength to transfer shear forces therebetween;
and at least one mechanical connector welded to at least one outer plate, the mechanical connector comprising a cylindrical metal body extending into said core generally perpendicularly to said one outer plate.

2. A structural sandwich plate member according to claim 1 wherein said mechanical connector has been welded to one of said outer plates by arc stud welding prior to formation of said core.

3. A structural sandwich plate member according to claim 2 wherein a plurality of mechanical connectors are provided, each of said outer plates at least one connector welded thereto.

4. A structural sandwich plate member according to claim 1 wherein the or each mechanical connector has an enlarged head.

5. A structural sandwich plate member according to claim 1 wherein the or each mechanical connector extends for only part of the thickness of said core.

6. A structural sandwich plate member according to claim 1 wherein the or each mechanical connector extends the full thickness of said core.

7. A structural sandwich plate member according to claim 1 wherein said mechanical connector extends through a hole in a first one of said outer plates and has been friction welded to said first outer plate after formation of said core.

8. A structural sandwich plate member according to claim 7 wherein said mechanical connector extends through the full thickness of said core and has been friction welded to the other of said outer plates.

9. A structural sandwich plate member according to claim 7 wherein said mechanical connector has been ground flush with the outer surface of said first outer plate.

10. A structural sandwich plate member according to claim 7 wherein said mechanical connector has a head projecting from the outer surface of said first outer plate.

11. A structural sandwich plate member according to claim 10 wherein said head has an exposed thread.

12. A structural sandwich plate member according to claim 7 wherein said mechanical connector has an enlarged head, a shank and a bevel joining said head to said shank; and said hole is countersunk to match said bevel.

13. A structural sandwich plate member according to claim 1 wherein said mechanical connector extends the full thickness of the core and its distal end has been welded to the other one of said outer plates through a perforation in said other outer plate.

14. A method of manufacturing a structural sandwich plate member comprising the steps of:
providing first and second outer metal plates,
welding at least one stud to at least one of said outer plates; placing said outer plates in a spaced-apart relationship with said at least one stud projecting into the space defined between said outer plates;
injecting uncured plastics or polymer material to fill said space defined between said outer plates; and
allowing said plastics or polymer material to cure to bond said outer plates together with sufficient strength to transfer shear forces therebetween.

15. A method according to claim 14 wherein said welding step is performed by electric arc stud welding.

16. A method of attaching a shear stud to a structural sandwich plate member comprising first and second outer metal plates and a core of plastics or polymer material bonded to said outer plates with sufficient strength to transfer shear forces therebetween, the method comprising the steps of:
drilling a hole through a first one of the outer plates of said structural sandwich plate member and into the core thereof;
providing a stud;
inserting said stud into said hole and welding said stud to said first outer plate.

17. A method according to claim 16 wherein said stud has an enlarged head, a shank and a bevel joining said head to said shank; and comprising the further step of countersinking said hole to match said bevel.

18. A method according to claim 16 wherein said drilling step comprises drilling a hole the full thickness of the core; said stud is long enough to reach the other of said outer plates and said step of welding further comprises welding said stud to said other outer plate.

19. A method according to claim 16 wherein said welding step is carried out by friction welding.

20. (canceled)

21. (canceled)

22. (canceled)
